(19) United States
(12) Patent Application Publication
(10) Pub. No.: US 2005/0195443 A1
(43) Pub. Date: Sep. 8, 2005

(54) Method and apparatus for processing images

(75) Inventor: Ryuji Saneto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/073,527

(22) Filed: Mar. 8, 2005

(30) Foreign Application Priority Data
Mar. 8, 2004 (JP) 2004-063416

(51) Int. Cl. H04N 1/405; H04N 1/52

(52) U.S. Cl. 358/3.14; 358/535; 358/3.23

(57) ABSTRACT

The image processing method and apparatus use a digital half-toning technique. The method and apparatus split a continuous tone image into split regions, compute an area size of each of the split regions and select an optimum halftone best suited to each of the split regions depending on the thus computed area size of each of the split regions. The program implements the above image processing method by control with a computer. The above program is written to the recording medium and can be read with the computer from the recording medium.

### BACKGROUND OF THE INVENTION

This invention relates to an image processing method and apparatus, a program implementing the image processing method and a recording medium to which the program is written.

More particularly, the invention relates to a method and an apparatus for processing images by which multi-level input halftone image data is subjected to multi-level dithering so that it is transformed to image data having a smaller number of tones, a program implementing the image processing method by control with a computer and a recording medium to which the program is written and from which it can be read with the computer.

Conventional image forming apparatuses such as a printer equipped with a line head form a binary image by two basic methods: in one method, dots of equal size are printed on a recording medium while keeping the resolving power of the head, or the distance between adjacent recording elements in the raster direction; in the other method, dots are printed at a resolution finer than the distance between adjacent recording elements by making plural scans with the head's position being changed in the raster direction.

In those image forming apparatuses, images such as letters and line images are simply reproduced as binary image with the resolving power of the head whereas continuous tone images such as photographic image are reproduced by pseudo-halftone processes such as ordered dithering and error diffusion. However, the pseudo-halftone process has had the following problems.

Consider, first, the case where the image forming apparatus equipped with a line head performs printing by ordered dithering. As the density of printing dot rows (which is hereunder referred to as the number of lines (screen ruling) increases, the size of individual dots and, hence, the precision of marking with dots, decreases to increase graininess; on the other hand, as the number of lines (screen ruling) decreases, the periodic pattern of dots (commonly referred to as raster) becomes visible. From the viewpoint of photographic image quality, neither phenomenon is desirable.

This means if the number of lines (screen ruling) across the image is fixed at a single value, either of the defects mentioned above will come out noticeably, i.e., conspicuous graininess or visible raster.

In connection with these problems, reference may be had to JP 10-191054A and JP 2003-234893A.

The techniques disclosed in those patents share the common feature of detecting the edge portions of an image and in the case of JP 10-191054A, the flat and edge portions are subjected to different multi-level dithering processes whereas a dithering threshold is selectively applied in the case of JP 2003-234893A. However, the above-described problems are not particularly addressed by either of those techniques.

### SUMMARY OF THE INVENTION

The present invention has been accomplished in view of these circumstances. It has as an first object providing an image processing method that is free from the aforementioned problems with the prior art techniques and which can perform half-toning without causing increased graininess or visible raster.

Another object of the present invention is to provide a program implementing this image processing method by control with a computer and a recording medium to which this program is written and from which it can be read with the computer.

Second object of the present invention is to provide an image processing apparatus for implementing this image processing method.

In order to attain the first object described above, the first aspect of the invention provides an image processing method using or based on a digital half-toning technique, comprising: splitting a continuous tone image into split regions; computing an area size of each of the split regions; and selecting an optimum halftone best suited to each of the split regions depending on the computed area size of each of the split regions.

It is preferable that the splitting step comprises: transforming the continuous tone image to categorical color images; considering, for each of the categorical color images, a continuous region continuing in one color to be a single region; and assigning the single region to one of the split regions, and wherein the optimum halftone is selected depending on the area size of each of the split regions. That is to say, when the continuous tone image is split into plural regions, the continuous tone image is preferably transformed to images in categorical colors or categorical color images and regions continuous in the same color are considered to be one and the same region, and the optimum halftone is selected depending on the area size of each of such regions.

It is further preferable that the selecting step of the optimum halftone comprises choosing a first threshold matrix with a larger number of lines (screen ruling) when the area size is small whereas a second threshold matrix with a smaller number of lines (screen ruling) when the area size is large. That is to say, a preferred method of selecting the optimum halftone is such that a first threshold matrix with a larger number of lines (screen ruling) is chosen when the area size of the split region is small whereas a second threshold matrix with a smaller number of lines (screen ruling) is chosen when the area size of the split region is large.

The image processing method of the invention can be implemented by control with a computer, so it can be sold on the market as a computer-controlling program. The invention can also be embodied as a recording medium to which the program is written and from which it can be read with a computer, and as an image processing apparatus that has the program installed in an image processing section to enable executing the above-described image processing procedure.

In order to attain another object described above, the second aspect of the invention provides a program implementing the image processing method of the first aspect of the invention by control with a computer.

In order to attain another object described above, the third aspect of the invention provides a recording medium to which the program of the second aspect of the invention is written and from which it can be read with the computer.

In order to attain second object described above, the fourth aspect of the invention provides an image processing apparatus equipped with image processing means using a digital half-toning technique, the image processing means comprising: splitting means having a capability of splitting a continuous tone image into split regions; area computing means having a capability of computing an area size of each of the split regions; and selecting means having a capability of selecting an optimum halftone best suited to each of the split regions depending on the area size of each of the split regions.

It is preferable that the splitting means comprises: transforming means for transforming the continuous tone image to categorical color images; considering means for considering, for each of the categorical color images, a continuous region continuing in one color to be a single region; and assigning means for assigning the single region to one of the split regions, and the selecting means selects the optimum halftone depending on the area size of each of the split regions.

It is further preferable that the selecting means comprises: area evaluating means for evaluating the area size of each of the split regions by comparing to a threshold; and determining means for determines a threshold matrix depending upon the evaluated area size.

It is still further preferable that the determining means chooses a first threshold matrix with a larger number of lines (screen ruling) when the area evaluating means evaluates that the area size is small than the threshold and a second threshold matrix with a smaller number of lines (screen ruling) when the area evaluating means evaluates that the area size is large than the threshold.

According to the present invention, two significant advantages are obtained, one is realizing an image processing method which is free from the aforementioned problems with the prior art techniques and which can perform half-toning without causing increased graininess or visible raster, and the other is realizing an apparatus for implementing that method.

A few words are added to clarify the heart of the present invention, which has been accomplished in light of one characteristic of the human vision, i.e., the visual acuity is the highest at and near the point the viewer fixes his or her eyes on and tends to decrease progressively away from it. Speaking of a raster, it can be seen clearly when the viewer observes a tiny region in the image on account of increased visual acuity for that region but if the viewer observes a large-area region, the resolving powers of the eyes are averaged and the raster no longer bothers the viewer. The same is true with graininess and it tends to be more conspicuous in a large-area region than in a tiny region.

Hence, in a halftone image, particularly one that is created by ordered dithering, the raster becomes less conspicuous with an increased number of lines (screen ruling) but, on the other hand, dots become unstable enough to increase graininess. If the number of lines (screen ruling) is decreased, graininess decreases but then the raster becomes conspicuous.

The present invention has been accomplished on the basis of this finding and, as already mentioned, an optimum half-toning method is adopted depending on the size of each of the regions into which an image of interest has been split and by so doing, the halftone image can be transformed in a direction that allows the viewer to have a feeling of seeing an image of higher quality.

### BRIEF DESCRIPTION OF THE DRAWINGS

FIG. 1 is a flow chart illustrating an outline of the present invention;

FIG. 2 is a flow chart illustrating a sequence of specific operations for selection between threshold matrices in one embodiment of the image processing method of the invention;

FIG. 3 shows an exemplary input original image;

FIG. 4 shows categorical color images to which the image shown in FIG. 3 has been transformed;

FIG. 5 shows the result of size evaluation on the areas of regions in the categorical color images shown in FIG. 4;

FIG. 6 is a schematic diagram illustrating the result of reproduction from selecting a suitable threshold matrix on the basis of the result shown in FIG. 5; and

FIG. 7 is a block diagram showing the configuration of an image processing apparatus incorporating an image processing section that embodies the image processing method according to the embodiment shown in FIG. 2.

### DETAILED DESCRIPTION OF THE INVENTION

Hereinafter, an image processing method and apparatus, a program implementing the image processing method and a recording medium to which the program is written according to the present invention will be described in detail based on preferred embodiments shown in the accompanying drawings.

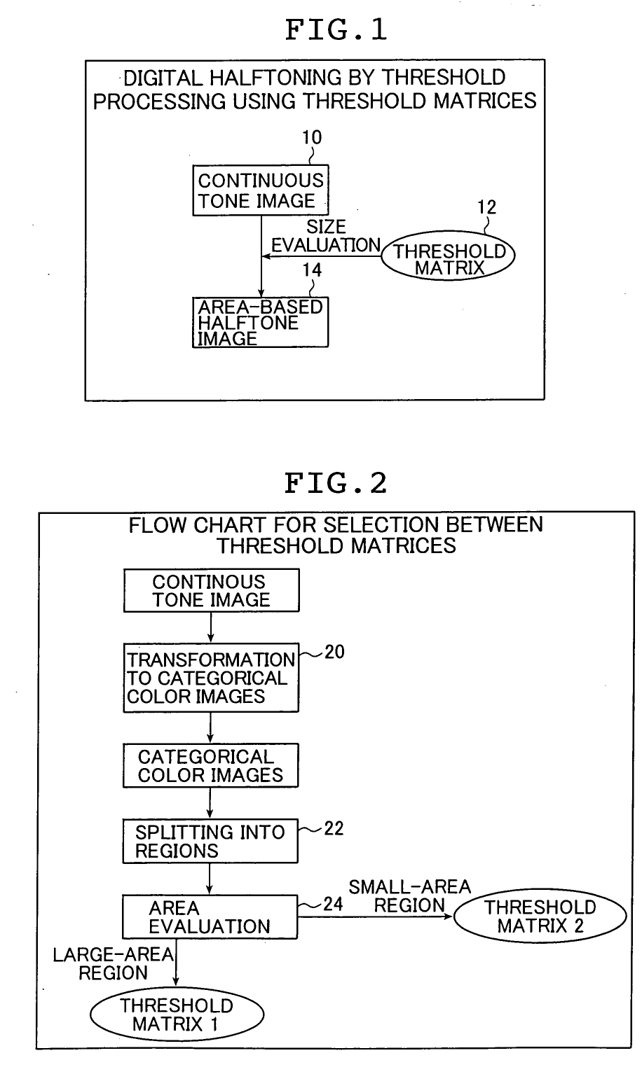

FIG. 1 is a flow chart illustrating the basic concept of the present invention. As shown, a continuous tone image 10 is split into split regions and depending on the area size of each of those regions, a suitable threshold matrix 12 is selected and applied to transform the continuous tone image 10 to a digital area-based halftone image 14.

On the pages that follow, the present invention is described in greater detail with reference to the preferred embodiment shown in accompanying FIGS. 2-7.

FIG. 2 is a flow chart illustrating a sequence of specific operations for selection between threshold matrices in one embodiment of the image processing method of the invention.

In the embodiment under consideration, regional splitting of a color continuous tone image is performed by a process which comprises transforming it to categorical color images or images in categorical colors (step 20), splitting the color continuous tone image into split regions (step 22), combining those regions which are continuous in the same categorical color (one color) into a single region and determining its area or area size (step 24), and applying different threshold matrices depending on the determined value.

Stated more specifically, the process of applying different threshold matrices depending on the area (size) of a region comprises applying a threshold matrix with a larger number of lines (screen ruling) to a region whose area is less than a specified value (threshold) and applying a threshold matrix with a smaller number of lines (screen ruling) to a region whose area is equal to or larger than the specified value (threshold). By this process, the original image can be transformed in a direction that allows the viewer to have a feeling of seeing an image of higher quality.

Transformation to the categorical color images in step 20 is based on another characteristic of the human vision which has been reported as follows: the shape of an image the viewer has ever seen is retained in his or her memory with a fairly good precision whereas the color of the image shifts in memory towards the center of a basic categorical color.

In the art of image processing, eleven basic categorical colors are designated and they are red, green, yellow, blue, brown, violet, orange, pink, gray, white and black; the use of these eleven colors is characterized in that a considerable amount of information can be compressed without altering the subjective impression of the original image.

Note that transformation from common colors to categorical colors is performed on the basis of a transformation table by which a large number of color patches are individually classified depending on which of the eleven categorical colors listed above a particular color patch is the nearest to.

In the embodiment under consideration, the eleven categorical colors listed above are employed to realize efficient regional splitting of the original image. The process is described below in greater detail.

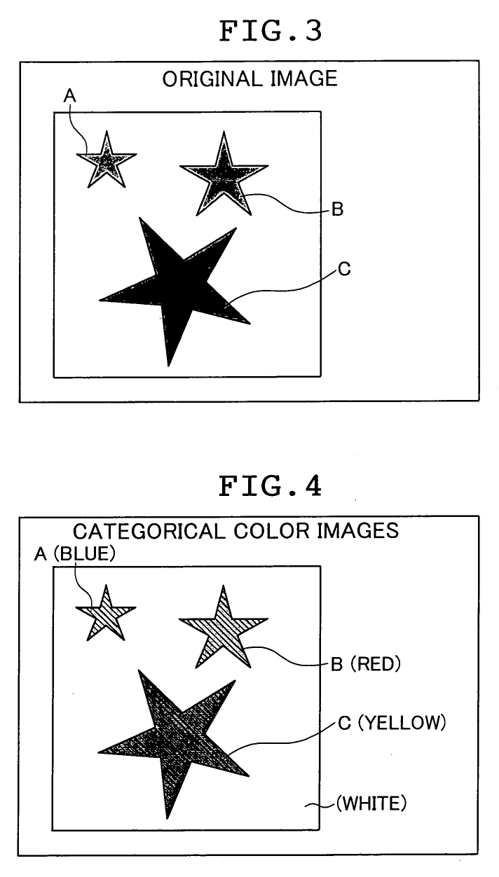

FIG. 3 shows an example of a common continuous tone image (original image) to be processed, in which the respective stars (images) are painted with arbitrary colors. FIG. 4 shows the result of transforming the colors of those stars to the corresponding categorical colors using the aforementioned transformation table.

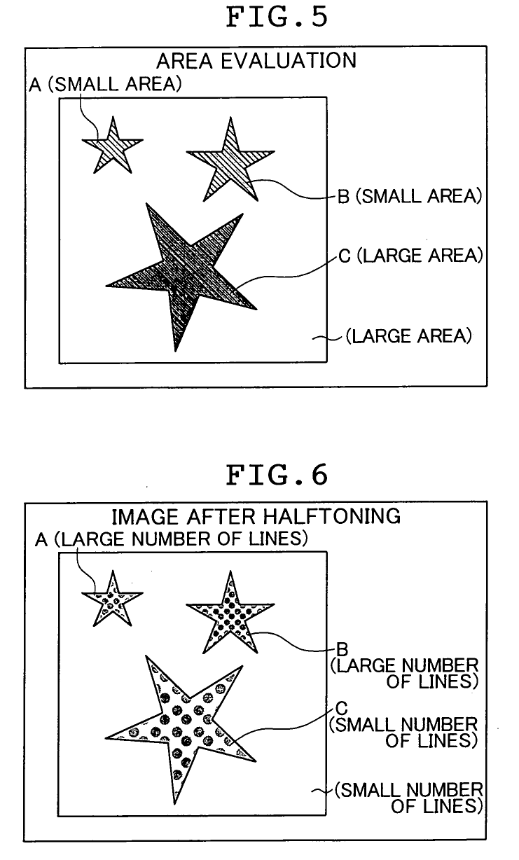

In the case shown in FIG. 4, there are four regions that belong to four categorical colors, so the areas of those regions are each compared with a predetermined threshold. Assume here that the areas (area sizes) of stars A and B are smaller than the predetermined threshold whereas the areas (area sizes) of star C and the background portion are larger than the threshold (see FIG. 5).

In this case, on the basis of the aforementioned characteristic of human vision, a threshold matrix 1 (one having a larger number of lines (screen ruling)) is applied to stars A and B whose areas are smaller than the threshold and a threshold matrix 2 (one having a smaller number of lines (screen ruling)) is applied to star C and the background portion whose areas are larger than the threshold. Both matrices are also predetermined.

FIG. 6 shows schematically the result of reproduction from applying a suitably selected threshold matrix.

By means of the thus determined threshold matrices, the image data is dithered and used to reproduce an image which does not bother the viewer in terms of either the graininess of the large-area regions (star C and the background portion) or the raster in the small-area regions (stars A and B) and which therefore brings about a significant practical benefit in that it is apparently recognized by the viewer as an image of an extremely high quality.

In the embodiment just described above, a continuous tone image is transformed to categorical color images, the areas (area sizes) of regions of the respective categorical colors (images) are calculated and compared with a predetermined threshold to classify those regions into two groups, one having a larger area and the other a smaller area, and threshold matrices which are also predetermined are applied to the respective groups. This is a simple process and yet the result is quite desirable as shown above.

On the pages that follow, a specific example is described with reference to the threshold which is used in evaluating the area (size) of each of the regions of categorical colors (images) to which the original image has been transformed.

If the area (size) of a region of a particular categorical color is written as S, the screen to be used is determined by the following criterion:
(1) if S<9 mm² (corresponding to 3 mm×3 mm), a screen consisting of a larger number of lines (screen ruling: 200 lines) is used; or
(2) if S≧9 mm², a screen consisting of a smaller number of lines (screen ruling: 175 lines) is used.

In the above expressions, S represents the area on an output print. Hence, in the case of printing from an output device of 2400 dpi, S=9 mm² is equivalent to 80352 pixels.

In practice, the resolution of the original image is often lower than the resolving power of the output device and resolution transformation needs to be performed by bicubic, bilinear or otherwise method to make adjustment to the output resolution.

In addition, transformation to categorical colors and calculation of regional areas can be effected faster on the original image than on the output image. For example, if the input image has a resolution of 300 dpi, S=9 mm² for the output image is equivalent to 1255 pixels.

If desired, two boundary values of area may be provided for the purpose of classification into three groups of area, large, medium and small, and the area (size) of each of the aforementioned regions in categorical colors may be compared with those two boundary values of area; as for a region whose area is in between those two boundary values of area, either one of the aforementioned two threshold matrices may be applied arbitrarily. In yet another alternative method, a third threshold matrix may be selected that has lines (screen ruling) whose number is in between the two numbers of lines (screen ruling), one for a large area and the other for a small area.

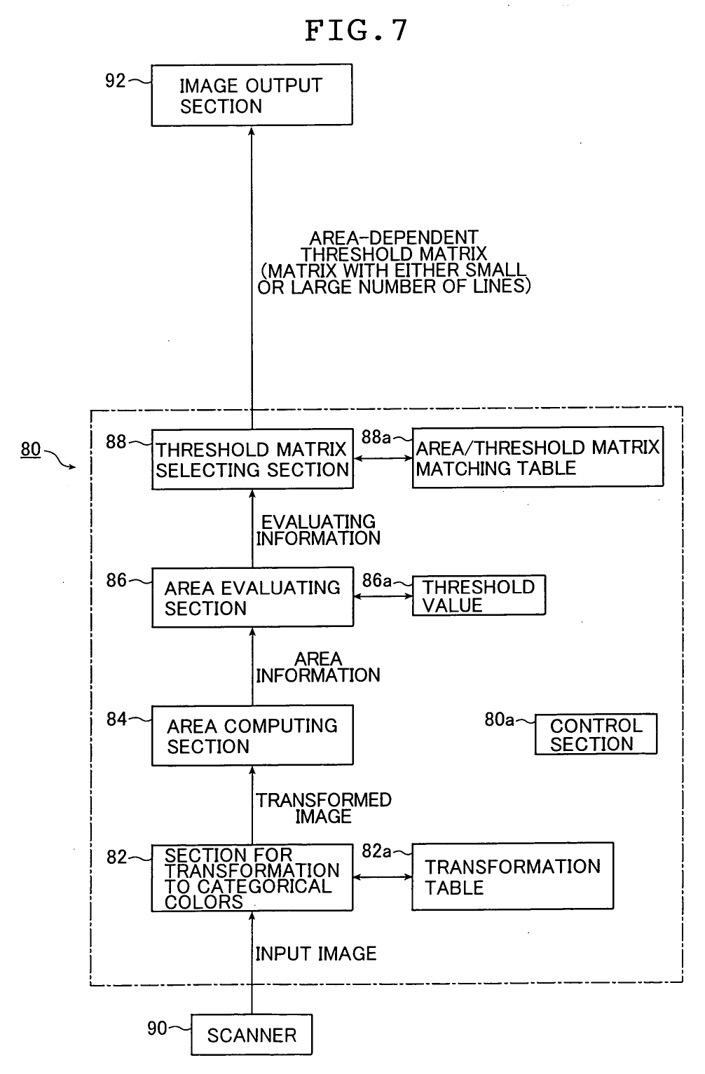

FIG. 7 is a block diagram of an image processing apparatus equipped with an image processing means that employs the image forming method according to the embodiment described above.

The image processing means according to the embodiment under consideration is generally indicated by 80; an input image from a scanner 90 is processed in accordance with the above-described procedure of image processing and then sent out to an image output section 92.

The image processing means 80 according to the embodiment under consideration comprises a section for transformation to categorical color 82 which is furnished with a transformation table 82a of the type described above, an area computing section 84 for determining the area of a transformed image, an area evaluating section 86 having thresholds 86a for evaluating the size of a regional area, a threshold matrix selecting section 88 having an area/threshold matrix matching table 88a which determines (selects) a relevant threshold matrix depending upon the size of a regional area, and a control section 80a which controls the aforementioned sections.

The image processing means 80 according to the embodiment under consideration operates in entirely the same manner as in the already described image processing method (see FIG. 2) and the overlaps are not described here. Essentially, in response to the operator's command for start, the respective (processing) sections described above execute the aforementioned operations under control of the control section 80a so that a threshold matrix appropriate for each of the regions into which the original image has been split is selected (determined) and sent out to the image output section 92.

It should be noted that the above-described embodiments are just exemplary of the present invention and by no means intended to limit its scope. Needless to say, various alterations and improvements can be made without departing from the scope and spirit of the invention.

For instance, the method of splitting the original image into split regions is not essential to the present invention and, hence, is by no means limited to the exemplary method described in the embodiments that consists of transformation to categorical colors. In color image processing, the image to be processed carries a large amount of information and comprises quite a large number of colors, making it important to devise an efficient method of splitting that image into split regions. In this respect, the method described in the embodiments that consists of transformation to categorical colors which in a memory are labeled as identical colors is effective in regional splitting since it is based on a characteristic of the human vision that is associated with the classification of colors.

The effectiveness in regional splitting of the exemplary method that is described in the embodiments and which consists of transformation to categorical colors is not reduced even if identical colors in the original image have a certain degree of gradation.

Note that the concept of the present invention is also applicable to black-and-white or single-colored (monotonic) images if the number of tones is sufficiently reduced to allow for area calculation on the basis of image brightness.

The threshold for evaluating the size of each of the split regions can also be set at appropriate values depending upon various factors including the image to be processed and the type of the printing medium used.

The above-described image processing procedure which comprises transforming a continuous tone image to categorical color images, calculating the areas (area sizes) of regions of the respective categorical colors, comparing them with a predetermined threshold to classify those regions into two groups, one having a larger area and the other a smaller area, and applying threshold matrices which are also predetermined to the respective groups can be automated by computer control.

In addition, the present invention can be sold on the market as a computer-controlling program for materializing automated image processing. The invention can also be embodied as a recording medium to which the program is written and from which it can be read with a computer, and as an image processing apparatus that has the program installed in an image processing section to enable executing the above-described image processing procedure.

1. An image processing method using a digital half-toning technique, comprising:
splitting a continuous tone image into split regions;
computing an area size of each of said split regions; and
selecting an optimum halftone best suited to each of said split regions depending on said computed area size of each of said split regions.

2. The image processing method according to claim 1, wherein said splitting step comprises:
transforming said continuous tone image to categorical color images;
considering, for each of said categorical color images, a continuous region continuing in one color to be a single region; and
assigning said single region to one of said split regions, and
wherein said optimum halftone is selected depending on said area size of each of said split regions.

3. The image processing method according to claim 1, wherein said selecting step of said optimum halftone comprises choosing a first threshold matrix with a larger number of lines when said area size is small whereas a second threshold matrix with a smaller number of lines when said area size is large.

4. A program implementing a image processing method using a digital half-toning technique by control with a computer, said image processing method comprising:
splitting a continuous tone image into split regions;
computing an area size of each of said split regions; and
selecting an optimum halftone best suited to each of said split regions depending on said computed area size of each of said split regions.

5. The program according to claim 4, wherein said splitting step comprises:
transforming said continuous tone image to categorical color images;
considering, for each of said categorical color images, a continuous region continuing in one color to be a single region; and
assigning said single region to one of said split regions, and
wherein said optimum halftone is selected depending on said area size of each of said split regions.

6. The program according to claim 4, wherein said selecting step of said optimum halftone comprises choosing a first threshold matrix with a larger number of lines when said area size is small whereas a second threshold matrix with a smaller number of lines when said area size is large.

7. A recording medium to which a program implementing a image processing method using a digital half-toning technique by control with a computer is written and from which it can be read with said computer, said image processing method comprising:
splitting a continuous tone image into split regions;
computing an area size of each of said split regions; and
selecting an optimum halftone best suited to each of said split regions depending on said computed area size of each of said split regions.

8. The recording medium according to claim 7, wherein said splitting step comprises:
transforming said continuous tone image to categorical color images;
considering, for each of said categorical color images, a continuous region continuing in one color to be a single region; and
assigning said single region to one of said split regions, and
wherein said optimum halftone is selected depending on said area size of each of said split regions.

9. The recording medium according to claim 7, wherein said selecting step of said optimum halftone comprises choosing a first threshold matrix with a larger number of lines when said area size is small whereas a second threshold matrix with a smaller number of lines when said area size is large.

10. An image processing apparatus equipped with image processing means using a digital half-toning technique, said image processing means comprising:
splitting means having a capability of splitting a continuous tone image into split regions;
area computing means having a capability of computing an area size of each of said split regions; and
selecting means having a capability of selecting an optimum halftone best suited to each of said split regions depending on said area size of each of said split regions.

11. The image processing apparatus according to claim 10, wherein said splitting means comprises:
transforming means for transforming said continuous tone image to categorical color images;
considering means for considering, for each of said categorical color images, a continuous region continuing in one color to be a single region; and
assigning means for assigning said single region to one of said split regions, and
wherein said selecting means selects said optimum halftone depending on said area size of each of said split regions.

12. The image processing apparatus according to claim 10, wherein said selecting means comprises:
area evaluating means for evaluating said area size of each of said split regions by comparing to a threshold; and
determining means for determines a threshold matrix depending upon said evaluated area size.

13. The image processing apparatus according to claim 12, wherein said determining means chooses a first threshold matrix with a larger number of lines when said area evaluating means evaluates that said area size is small than said threshold and a second threshold matrix with a smaller number of lines when said area evaluating means evaluates that said area size is large than said threshold.
